(19) United States
(12) Patent Application Publication
(10) Pub. No.: US 2013/0199064 A1
(43) Pub. Date: Aug. 8, 2013

(54) SIGNS

(71) Applicant: Saf-T-Glo Limited, Norfolk (GB)

(72) Inventor: Sean Patrick O'Kell, Norfolk (GB)

(73) Assignee: Saf-T-Glo Limited, Norfolk (GB)

(21) Appl. No.: 13/760,901

(22) Filed: Feb. 6, 2013

(30) Foreign Application Priority Data
Feb. 8, 2012 (GB) 1202190.3

(51) Int. Cl. G09F 13/04

(52) U.S. Cl. CPC G09F 13/04
USPC 40/542

(57) ABSTRACT

A sign has a sign plate mounted in a frame to display an image such as the word “EXIT” when illuminated. The sign includes an electrically powered light source configured for edge lighting of the sign. The sign plate has a front portion, a rear portion and an intermediate portion between the front and rear portions. The rear portion provides a photoluminescent light source for back lighting the sign. The sign is edge lit when the electrically powered light source is in use and is backlit by the photoluminescent light source in darkness or low ambient light conditions when the electrically powered light source is not in use.

### CROSS-REFERENCE TO RELATED PATENT APPLICATIONS

The present application claims priority to and the benefit of United Kingdom Patent Application No. 1202190.3, filed Feb. 8, 2012, the disclosure of which (including the specification, drawings, claims, and abstract thereof) is incorporated herein by reference in its entirety.

### BACKGROUND

This invention relates to signs. The invention has particular, but not exclusive application to signs used in buildings, ships, aircraft, buses, trains and the like to identify an exit and/or to indicate a path or route to an exit. Such signs may be used to assist people escape from buildings, ships, aircraft, buses, trains and the like in an emergency situation. Such signs may be provided at or near to an exit so as to assist in identifying the exit. Such signs may also be provided as part of an escape system configured to guide people towards and identify an exit.

### SUMMARY

According to an exemplary embodiment, a sign is configured to display an image when illuminated. The sign includes an electrically powered light source configured for edge lighting of the sign and a photoluminescent light source configured for back lighting of the sign. The sign has a front portion, a rear portion and an intermediate portion between the front and rear portions. The rear portion includes the photoluminescent light source, the arrangement being such that the sign is edge lit when the electrically powered light source is in use and is backlit by the photoluminescent light source in darkness or low ambient light conditions when the electrically powered light source is not in use.

### BRIEF DESCRIPTION OF THE DRAWINGS

The invention will now be further described by way of example only with reference to the following drawings in which:

FIG. 1 is a perspective view of a sign in accordance with the invention;

FIG. 2 is a side perspective view of an inner portion of the sign; and

FIG. 3 is a side view of the inner portion of FIG. 2.

### DETAILED DESCRIPTION

It is known to provide signs with electrical lighting to enable them to be more readily visible. In an emergency, electrical power may be lost and an emergency sign relying on electrical lighting then lacks illumination and may not be visible. In passenger vehicles in particular it is important to provide signs that are visible even in the case of a loss of electrical power. This is of particular importance in passenger transport vehicles such as aircraft and ships. Safety requirements in aircraft specify that a back up power system must be provided. Typically a back up system comprises a battery powered lighting system and safety regulations specify that the battery must supply power to the lighting systems for at least ten minutes. However it is also known that it may take longer than ten minutes to evacuate a plane and if the battery fails before evacuation is completed remaining passengers and personnel may have difficulty in locating the exit. Additionally if breakup of the vehicle or aircraft occurs the lighting system circuits may be broken and the lighting may fail completely even if a back up battery powered system is provided.

According to a first aspect of the invention there is provided a sign configured to display an image when illuminated, the sign including an electrically powered light source configured for edge lighting of the sign and a photoluminescent light source configured for back lighting of the sign, wherein the sign has a front portion, a rear portion and an intermediate portion between the front and rear portions, and wherein the rear portion includes the photoluminescent light source, the arrangement being such that the sign is edge lit when the electrically powered light source is in use and is backlit by the photoluminescent light source in darkness or low ambient light conditions when the electrically powered light source is not in use.

An advantage of the combined electrically powered light source and photoluminescent light source in the sign of the present invention is that the sign can be illuminated by the electrically powered light source so as to be visible both in daylight and in darkness. In addition, the sign can be illuminated by the photoluminescent light source if there is a loss of electrical power so as to visible in darkness.

In this way, the photoluminescent light source provides a back-up to the electrically powered light source for illuminating the sign in darkness if the electrically powered light source is inoperable for any reason at the time illumination is required, for example due to interruption of the electric power supply or failure of the electrically powered light source.

It may be that the sign comprises a frame and a sign plate or panel mounted therein. It may be that the electrically powered light source is located within the frame and provides illumination of the sign plate from one or more edges thereof

The frame may define an opening having an edge feature for locating the sign plate. The edge feature may comprise an inwardly directed channel or groove in which a marginal edge of the sign plate is received and retained.

It may be that the electrically powered light source is located within the groove or channel such that light emitted by the electrically powered light source is confined and directed to illuminate the sign plate from one or more edges thereof. It may be that the electrically powered light source provides illumination along at least two edges of the sign plate.

It may be that the electrically powered light source provides a source of visible light. The visible light illuminates the sign and may also charge the photoluminescent light source. The electrically powered light source may additionally provide a source of non-visible light. The non-visible light source may charge the photoluminescent light source. It may be that the electrically powered light source provides a source of ultra-violet (UV) light. UV light may charge the photoluminescent light source more efficiently than the visible light source.

It may be that the electrically powered light source comprises one or more light emitting diodes (LEDs). It may be that some or all LEDs provide visible light only, for example white light. It may that one or more LEDs provide non-visible light only, for example UV light. It may be that some or all LEDs provide a combination of visible and non-visible light. It may be that a mixture of LEDs providing visible light and LEDs providing non-visible light is used in combination. The use of at least some LED's emitting non-visible light may be desirable to maximise charging efficiency of photoluminescent material employed for the photoluminescent light source.

In one embodiment it may be that LEDs providing visible light and LEDs providing non-visible light are alternated along one or more sides of the frame. In another embodiment it may be that LEDs providing visible light are provided along one side of the frame and LEDs providing non-visible light are provided along another side of the frame. In another embodiment, it may be that LEDs providing visible light are provided along first opposing sides of the frame and LEDs providing non-visible light are provided along second opposing sides of the frame between the first opposing sides. Any other suitable electrically powered light sources may be used in place of LEDs.

The sign plate may include an image comprising one of more of text, graphics, pictures or the like to provide information and/or assist identification of an escape route or exit to be used in the case of an emergency. For example the sign plate may include text such as the word “EXIT” or a picture such as the “running man” to identify an exit or the direction to an exit.

The sign plate may include a front portion, a rear portion and an intermediate portion.

The image may be provided on the front portion or may be provided on the intermediate portion behind the front portion or a combination thereof. The image may be provided on a rear surface or front surface of the front portion or may be formed within the front portion between the rear surface and front surface. The image may be provided on a front surface of the intermediate portion. The image may be printed on the front portion or on the intermediate portion using inks or pigments or other conventional technology used in forming an image.

The intermediate portion may be arranged to provide a background to the image. The background may provide a contrasting color to the image in ambient light and/or when the sign is illuminated by the electrically powered light source or photoluminescent light source. The contrast may be enhanced when the sign is illuminated by the electrically powered light source or photoluminescent light source. The background or image may appear brighter when the sign is illuminated to increase the contrast and make the sign more readily visible.

The intermediate portion may reflect at least some of the light from the electrically powered light source forwards when the sign is illuminated. This may enhance the illumination of the sign and increase visibility of the image. This can be advantageous in providing information to assist escape in an emergency by identifying an exit and/or an escape path.

The intermediate portion may allow ambient light to pass through to the rear portion to charge the photoluminescent material. The intermediate portion may reflect at least some of the light from the electrically powered light source rearwards when the sign is illuminated. This may assist charging the photoluminescent material by a combination of ambient light and electrically powered light.

The intermediate portion may allow light emitted by the photoluminescent material to pass through. The light output from the photoluminescent material is low and is normally not visible in daylight or when the sign is illuminated by the electrically powered light source. When the electrically powered light source is turned off or is not working in conditions of low ambient light or in darkness, the light from the photoluminescent material passing through the intermediate portion can be sufficient to illuminate the sign so that the image is visible. As a result the sign can provide information to assist escape in an emergency by identifying an exit and/or an escape path even if the electrically powered light a source is not working.

The background may change color according to the lighting conditions. For example a white background in ambient light may change color when lit by light of different color from the electrically powered light source and/or the photoluminescent light source. Thus, the electrically powered light source may be configured to emit white light or light having any other color and the photoluminescent light source may emit a yellow/green light. Although the light output from the photoluminescent material is low compared to that of electrical lighting it can be sufficient to light the sign in the absence of electrical lighting.

According to a second aspect of the invention there is provided a sign having an electrically powered light source and a photoluminescent light source.

The sign may comprise a frame and an inner portion. The inner portion may comprise a front panel. The front panel may overlie the photoluminescent light source. It may be that the electrically powered light source comprises edge lighting. The edge lighting may be provided within the frame and illuminates the front panel of the sign. The edge lighting may be provided along at least one edge of the inner portion. The edge lighting may be provided along 2, 3, 4 or more edges of the inner portion. The edge lighting may comprise a source of visible light and optionally a source of non visible light. The source of non-visible light may be a source of UV light. The edge lighting may comprise one or more LEDs. It may be that the edge lighting comprises at least one LED providing a visible light source, for example white light, and at least one LED providing a non-visible light source, for example UV light. It may be that at least one LED provides both a visible light source, for example white light, and a non-visible light source, for example UV light.

It may be that the sign includes an image comprising one of more of text, graphics, pictures or the like. The image may be provided on a front panel or may be provided on a layer or film behind the front panel. The image may be formed within the front panel. It may be that a coating is provided between the photoluminescent light source and the front panel. The coating may be arranged to reflect light rays from the electrically powered light source. The coating may reflect light rays forwards. The coating may allow light to pass through.

According to a third aspect of the invention there is provided a vehicle having at least one exit, the vehicle also comprising at least one sign in accordance with the first or second aspects of the invention, an electrical power supply for the light source of the sign supply and the sign being configured to indicate an exit or a path to an exit.

The sign may be located on or adjacent to the exit.

The vehicle may comprise an aircraft.

A sign in accordance with the first or second aspects of the invention is particularly advantageous in aircraft as the sign is brightly lit and readily visible when illuminated by the electrically powered light source. In addition the photoluminescent light source provides passive lighting of the sign in case of a power failure. Additionally in case of breakup of the aircraft the sign will continue to provide guidance to the location of the exit even if there is no electrical supply or even if there is damage to the sign.

The photoluminescent light source may be charged by one or more of light from the electrically powered light source when the sign is illuminated and by ambient light.

The electrically powered light source may provide visible light to illuminate the sign. Visible light from the electrically powered light source may be used to charge the photoluminescent light source. The electrically powered light source may provide non-visible light that can be used to charge the photoluminescent light source. For example, if the cabin lighting is dimmed to provide a more restful environment for the passengers on the aircraft, the electrically powered light source may provide a source of non-visible light only that continues to charge the photoluminescent light source such that the sign can be illuminated by photoluminescent light. Thus, the electrically powered light source may comprise at least one visible light source and at least one non-visible light source. The non-visible light source or sources may remain operative if and when the visible light source or sources in the sign are turned off. The non-visible light source or sources continue to charge the photoluminescent material while the visible light source or sources are turned off.

According to a fourth aspect of the invention there is provided a lighting system for a vehicle comprising at least one sign in accordance with the first or second aspects of the invention adapted to indicate an exit or a path to an exit and further comprising an electrical power supply.

The sign may be located on or adjacent to the exit.

The lighting system may comprise at least one guidance track leading towards the sign. In one embodiment the guidance track comprises a passive lighting system. The track may comprise photoluminescent material. The track may comprise photoluminescent material provided with markers or images, for example arrows, indicating a direction towards a nearest exit. The track may comprise strips of photoluminescent material extending on one or both sides of a path leading to an exit. The strips of photoluminescent material may be substantially continuous along the path to the exit. The path may include a stairway connecting different levels or floors of a building, ship, aircraft, bus, train or the like. The track may include photoluminescent material to identify the stairway and in particular to identify the individual steps of the stairway.

The accompanying drawings depict a sign 1 in accordance with the invention. In this embodiment, the sign 1 is configured as an exit sign for use in an emergency to identify an exit. When the sign is illuminated, the word “EXIT” is visible against a background of contrasting color.

It will be appreciated that the invention is not limited to signs configured to display the word “EXIT” and that the sign may be configured to display any image which may comprise a word, text, logo, graphic, picture or combinations of any of these according to the intended application and position of the sign. The sign may be used in buildings, ships, aircraft, buses, trains to assist people escaping in an emergency situation. The sign may be provided as part of an escape system configured to guide people towards and identify an exit.

The sign 1 comprises a frame 2 and a sign plate or panel 4. The frame 2 is configured to provide an inwardly directed groove or channel 6 in which a marginal edge of the sign plate 4 is received and retained. The sign 1 is of rectangular shape although it will be understood that other shapes may be employed including but not limited to round, oval, triangular.

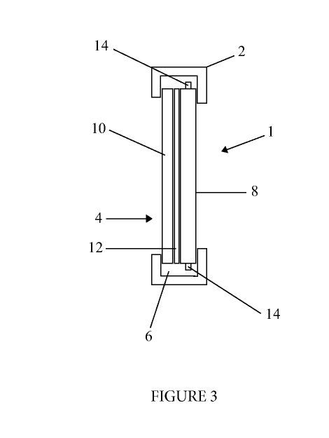

The sign plate 4 includes a front portion 8, a rear portion 10 and an intermediate portion 12 disposed between a rear surface of the front portion 8 and a front surface of the rear portion 10. The front, rear and intermediate portions 8, 10, 12 are shown as being separate from one another and spaced apart in FIG. 3. This is for clarity and it may be that the intermediate portion 12 is secured, for example bonded, to the rear surface of the front portion 8 and/or to the front surface of the rear portion 10.

The front portion 8 may comprise a plastics material that allows light to pass through. The front portion 8 may typically be formed of a transparent or translucent plastics material. The front portion 8 may be formed of polycarbonate although other materials can be used. The front portion 8 may comprise a sheet of plastics material. The sheet may comprise one or more layers of plastics material.

The intermediate portion 12 may comprise a coating or film. The coating or film may be applied to the rear surface of the front portion 8 or the front surface of the rear portion 10. The coating or film may be colored. The coating or film may typically be formed of a material that reflects and transmits light. The coating or film may be formed of titanium dioxide although other materials can be used. The coating or film may comprise one or more layers. Where the intermediate portion is a coating, the coating may be applied to the rear surface of the front portion 8 or the front surface of the rear portion 10 as one or more layers.

The rear portion 10 may comprise a photoluminescent light source provided, for example, by photoluminescent material suspended in a polymer material. The photoluminescent material may comprise strontium aluminate although other photoluminescent materials can be used. The rear portion 10 may comprise a sheet of polymer material. The sheet may comprise one or more layers of polymer material. Alternatively, the rear portion 10 may comprise a coating applied to the rear surface of the intermediate portion as one or more layers.

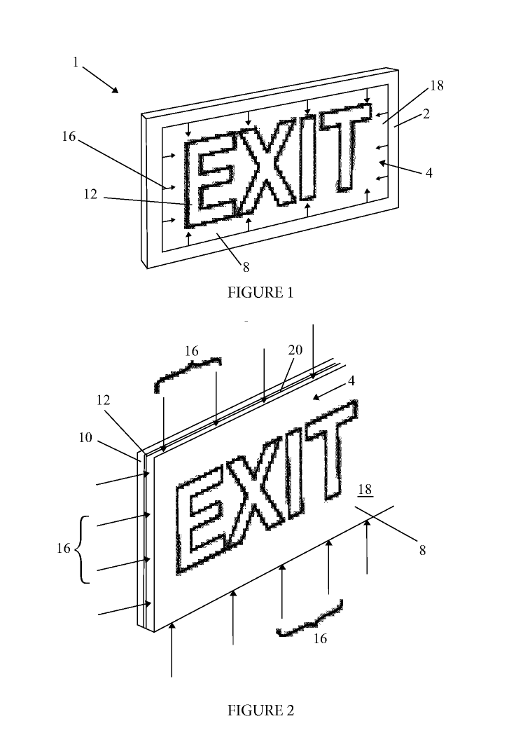

As best shown in FIG. 3, the sign 1 further includes an electrically powered light source 14 within the channel 6 of the frame 2. The light source 14 may be arranged to provide illumination from one or more edges of the sign plate 4. The light source 14 may provide illumination from the side edges, top edge and bottom edge of the sign plate 4 as generally indicated by the arrows 16 in FIGS. 1 and 2. The light source 14 may provide illumination of the front portion 8 of the sign plate 4. The intermediate portion 12 may reflect light from the electrically powered light source 14 forwardly through the front portion 8.

The word “EXIT” may be provided on the front portion 8, for example on the front surface or rear surface or between the front and rear surfaces of the front portion 8. Alternatively, the word “EXIT” may be provided on the intermediate portion 12. The word “EXIT” may be printed using inks or pigments or by any other suitable means.

The intermediate portion 12 provides a background 18 having a color configured to provide a contrast with the word “EXIT” so that the word “EXIT” is clearly visible when the sign 1 is illuminated by the electrically powered light source 14 in daylight or darkness. The intermediate portion 12 may be colored white or any other suitable color that provides a contrasting background color to the word “EXIT” so that the word is clearly visible.

The photoluminescent material of the rear portion 10 provides a low level passive light source when exposed to light through the intermediate portion 12, for example ambient light in daylight or light from the electrically powered light source 14, and continues to emit light when the light source is removed, for example in darkness or when the electrically powered light source 14 is not in use. The light emitted from the photoluminescent material is not seen in daylight or when the electrically powered light source is in use since the light output level of the photoluminescent material is very low compared to ambient light or the light from the electrically powered light source 14. However, in conditions of darkness or low ambient lighting when the electrically powered light source 14 is not in use, the light emitted from the photoluminescent material of the rear portion 10 that passes through the intermediate portion 12 is sufficient to provide illumination for the sign so that the word “EXIT” is visible.

The electrically powered light source 14 may emit visible light only or a combination of visible and non-visible light. The electrically powered light source 14 may comprise a plurality of LED lights powered by any suitable electrical power source, for example one or more batteries (not shown). There may be a combination of LED lights that emit either visible light, for example white light, or non-visible light, for example ultraviolet light. Alternatively, the LED lights may emit both visible and non-visible light.

The visible light, for example white light, may provide illumination of the front portion 8 and charge the photoluminescent material of the rear portion 10. The non-visible light, for example ultra-violet light, may help to charge the photoluminescent material of the rear portion 10 more efficiently than visible light so that the photoluminescent material is fully charged in the event of an emergency and the loss of electrically powered lighting.

The non-visible light may also be used to charge the photoluminescent material if it is desired to turn off the visible light source for any reason so as to keep the photoluminescent material charged to provide illumination of the sign over an extended period of low ambient light levels. For example in an aircraft, it may be that the cabin lighting is dimmed to provide a more restful environment for the passengers during which the sign is illuminated by the photoluminescent light source and non-visible light from the electrically powered light source is used for charging the photoluminescent material.

While the invention has been described with reference to exemplary embodiments, it will be understood that the invention is not limited thereto and that various modifications can be made within the scope of the invention as defined in the claims.

What is claimed is:

1. A sign configured to display an image when illuminated, the sign including an electrically powered light source configured for edge lighting of the sign and a photoluminescent light source configured for back lighting of the sign, wherein the sign has a front portion, a rear portion and an intermediate portion between the front and rear portions, and wherein the rear portion includes the photoluminescent light source, the arrangement being such that the sign is edge lit when the electrically powered light source is in use and is backlit by the photoluminescent light source in darkness or low ambient light conditions when the electrically powered light source is not in use.

2. The sign of claim 1 wherein the sign comprises a frame and a sign plate or panel mounted therein, and the electrically powered light source is located within the frame and provides illumination of the sign plate from one or more edges.

3. The sign of claim 2 wherein the frame defines an opening having an inwardly directed edge feature in which a marginal edge of the sign plate is received and retained, and the electrically powered light source is located within the edge feature such that light emitted by the electrically powered light source is confined and directed to illuminate the sign plate from one or more edges thereof

4. The sign of claim 3 wherein the sign plate is rectangular and the electrically powered light source provides illumination along at least two edges of the sign plate.

5. The sign of claim 2 wherein the electrically powered light source provides a source of visible light that illuminates the sign and also charges the photoluminescent light source.

6. The sign of claim 2 wherein the electrically powered light source provides a source of non-visible light that charges the photoluminescent light source.

7. The sign of claim 1 wherein the electrically powered light source comprises one or more light emitting diodes (LEDs).

8. The sign of claim 2 wherein the sign plate includes an image comprising one or more of text, graphics, pictures or the like to provide information and/or assist identification of an escape route or exit to be used in the case of an emergency.

9. The sign of claim 2 wherein the sign plate includes a front portion, a rear portion and an intermediate portion.

10. The sign of claim 9 wherein an image is provided on the front portion or on the intermediate portion behind the front portion or a combination thereof

11. The sign of claim 10 wherein the image is provided on a rear surface or front surface of the front portion or within the front portion between the rear surface and front surface.

12. The sign of claim 10 wherein the intermediate portion is arranged to provide a background to the image, and the background provides a contrasting color to the image in ambient light and/or when the sign is illuminated by the electrically powered light source or photoluminescent light source.

13. The sign of claim 12 wherein the contrast is enhanced when the sign is illuminated by the electrically powered light source or photoluminescent light source.

14. The sign of claim 13 wherein the background or image appears brighter when the sign is illuminated to increase the contrast and make the sign more readily visible.

15. The sign of claim 12 wherein the background changes color according to the lighting conditions.

16. The sign of claim 9 wherein the intermediate portion reflects at least some of the light from the electrically powered light source forwards when the sign is illuminated.

17. The sign of claim 9 wherein the intermediate portion allows ambient light to pass through to the rear portion to charge the photoluminescent material.

18. The sign of claim 9 wherein the intermediate portion reflects at least some of the light from the electrically powered light source rearwards when the sign is illuminated.

19. The sign of claim 9 wherein the front portion comprises a sheet of plastics material, the rear portion comprises photoluminescent material and the intermediate portion comprises a coating or film between a rear surface of the front portion and a front surface of the rear portion.

20. The sign of claim 9 wherein the intermediate portion allows light emitted by the photoluminescent material to pass through.
